(19) United States
(12) Patent Application Publication
(10) Pub. No.: US 2010/0214600 A1
(43) Pub. Date: Aug. 26, 2010

(54) IMAGE FORMING APPARATUS, DELIVERY SYSTEM, IMAGE PROCESSING METHOD, PROGRAM, AND RECORDING MEDIUM

(76) Inventor: Atsuko YAGI, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/690,362

(22) Filed: Jan. 20, 2010

(30) Foreign Application Priority Data
Feb. 25, 2009 (JP) 2009-042881

(51) Int. Cl. G06F 3/12

(52) U.S. Cl. 358/1.15

(57) ABSTRACT

A disclosed image forming apparatus includes a first control unit controlling functions of the image forming apparatus and including an output unit outputting, provided that first user authentication is successful, first user information including a first user identification information and password combination, and a second control unit controlling execution of a processing flow related to an image data delivery and including an acquisition unit acquiring the first user information including the first user identification information and password combination to be stored as second user information including a second user identification information and password combination in a storage unit, and an authentication control unit controlling second user authentication based on the second user identification information and password combination of the second user information. In the image forming apparatus, the first and the second control units operate in separate processes and respectively carry out the first and second user authentications.

### BACKGROUND OF THE INVENTION

1. Field of the Invention

The present disclosure generally relates to an image forming apparatus, a delivery processing system, an image processing method, a computer program thereof, and a recording medium having such a computer program.

2. Description of the Related Art

Recently, image input-output apparatuses such as multifunctional peripherals have increasingly been located on or connected via networks in many companies. Such image input-output apparatuses have improved the work efficiency dramatically. In the image input-output apparatuses, delivering processing systems that can efficiently convert paper documents into electronic documents and deliver the converted electronic documents draw much attention in terms of enhancing work efficiency. Major components of such a delivery processing system include an image input-output apparatus such as a scanner and a delivery management server. In the delivery management server, various delivery setting (processing flows) menus suitable for various services and applications are registered in advance. A user of the image input-output apparatus selects one of the processing flows suitable for a particular service such as scanning to scan a document via an operations panel (operations section) of the image input-output apparatus.

Japanese Patent Application Laid-Open Publication No. 2006-018640, for example, discloses an image data delivering processing technology in which an administrator combines plug-in programs for carrying out delivery processing and image conversion processing prepared in advance to create input-conversion-output processing flows, so that image data can be delivered based on the created input-conversion-output processing flows. In this technology, a set of applications controlling execution of the created processing flows is installed on an image forming apparatus, and a user of the image forming apparatus is authenticated by each of the applications, so that the authenticated user can deliver the image data based on the processing flows created by the user, thereafter.

There is a well-known set of applications produced by Equitrac Corporation, which controls execution of functions such as photocopying or sending faxes or key events of an operations screen of the image forming apparatus. These applications can rigorously control the functions of the image forming apparatus tailored to each user by tracing logs for the functions and authenticating the users.

However, in the disclosed image forming apparatus, different applications operate in separate processes, so that it is difficult to exchange information between the applications. For example, in the image forming apparatus, a user is required to login for each application, so that the user needs to input a user ID and the like to log in to each application, which is a cumbersome operation for the user. In addition, in a case where one of the applications is developed by a vendor differing from another application, the application may include a hidden application program interface (API), thereby making it difficult to exchange or transfer login information between the applications within the same image forming apparatus. Accordingly, a module for acquiring login information is provided in an external server so that the login information is transferred from one application to another application via the module.

### SUMMARY OF THE INVENTION

Accordingly, embodiments of the present invention may provide a novel and useful image forming apparatus, delivery processing system, image processing method, computer program thereof, and recording medium having such a computer program solving one or more of the problems discussed above. More specifically, the embodiments of the present invention may provide an image forming apparatus, a delivery processing system, an image processing method, a computer program thereof, and a recording medium having such a computer program capable of directly transferring and receiving information between applications that operate in separate processes.

According to an embodiment of the invention, there is provided an image forming apparatus including a first control unit configured to control functions of the image forming apparatus and include an output unit configured to output, provided that first user authentication is successful, first user information including a first user identification information and password combination; and a second control unit configured to control execution of a processing flow composed of types of processing related to an image data delivery and include an acquisition unit configured to acquire the first user information including the first user identification information and password combination output from the first control unit and store the first user information including the first user identification information and password combination acquired from the first control unit as second user information including a second user identification information and password combination in a storage unit, and an authentication control unit configured to control second user authentication based on the second user identification information and password combination of the second user information stored in the storage unit. In the image forming apparatus, the first and the second control units operate in separate processes and respectively carry out the first and second user authentications.

According to an embodiment of the invention, there is provided a delivery processing system including: an image forming apparatus including a first control unit configured to control functions of the image forming apparatus and include an output unit configured to output, provided that first user authentication is successful, first user information including a first user identification information and password combination, and a second control unit configured to control execution of a processing flow composed of types of processing related to an image data delivery and include an acquisition unit configured to acquire the first user information including the first user identification information and password combination output from the first control unit and store the first user information including the first user identification information and password combination acquired from the first control unit as second user information including a second user identification information and password combination in a storage unit, and an authentication control unit configured to control second user authentication based on the second user identification information and password combination of the second user information stored in the storage unit, the first and the second control units operating in separate processes and respectively carrying out the first and second user authentications; an authentication server configured to carry out the first user authentication for the first control unit of the image forming apparatus; and a delivery server configured to carry out the second user authentication for the second control unit of the image forming apparatus. In the delivery processing system, the first control unit of the image forming apparatus includes an output unit configured to output, provided that the first user authentication carried out by the authentication server is successful, the first user information including the first user identification information and password combination to the second control unit. Further, in the delivery processing system, the second control unit of the image forming apparatus includes an acquisition unit configured to acquire the first user information including the first user identification information and password combination output from the first control unit, and an authentication request unit of the image forming apparatus configured to request the delivery server to carry out the second user authentication based on the second user identification information and password combination of the second user information stored in the storage unit.

According to an embodiment of the invention, there is provided a method for processing an image in an image forming apparatus including a first control unit configured to control functions of the image forming apparatus and include an output unit configured to output, provided that first user authentication is successful, first user information including a first user identification information and password combination; and a second control unit configured to control execution of a processing flow composed of types of processing related to an image data delivery and include an acquisition unit configured to acquire the first user information including the first user identification information and password combination output from the first control unit and store the first user information including the first user identification information and password combination acquired from the first control unit as second user information including a second user identification information and password combination in a storage unit, and an authentication control unit configured to control second user authentication based on the second user identification information and password combination of the second user information stored in the storage unit, the first and the second control units operating in separate processes and respectively carrying out the first and second user authentications. The method includes: outputting, provided that the first user authentication is successful, the first user information including the first user identification information and password combination from the first control unit to the second control unit; acquiring the first user information including the first user identification information and password combination output from the first control unit to the second control unit; storing the first user information including the first user identification information and password combination acquired from the first control unit as the second user information including the second user identification information and password combination; and controlling the second user authentication based on the second user identification information and password combination of the second user information stored in the storage unit.

Additional objects and advantages of the embodiments will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

FIG. 1 is a diagram illustrating an operations example in a delivery processing system according to a first embodiment of the invention;

FIG. 2 is a block diagram illustrating a hardware configuration example of an image forming apparatus according to the first embodiment;

FIG. 3 is a block diagram illustrating a functional configuration example of the image forming apparatus according to the first embodiment;

FIG. 4 is a block diagram illustrating primary functional configuration examples of a multifunctional periphery, a function management server, and a delivery server according to the first embodiment;

FIG. 5 is a table illustrating an example of user information;

FIG. 6 is a diagram illustrating an example of XML formatted user information;

FIG. 7 is a diagram illustrating an example of an operations screen transitions;

FIGS. 8A and 8B are diagrams illustrating examples of a processing flow according to the first embodiment;

FIG. 9 is a flowchart illustrating an example of login processing according to the first embodiment;

FIG. 10 is a flowchart illustrating an example of logout processing according to the first embodiment;

FIG. 11 is a block diagram illustrating primary functional configuration examples of a multifunctional periphery, a function management server, and a delivery server according to a second embodiment;

FIGS. 12A and 12B are diagrams illustrating examples of a processing flow according to the second embodiment; and

FIG. 13 is a flowchart illustrating an example of money-charging processing according to the second embodiment.

### DETAILED DESCRIPTION OF THE PREFERRED EMBODIMENTS

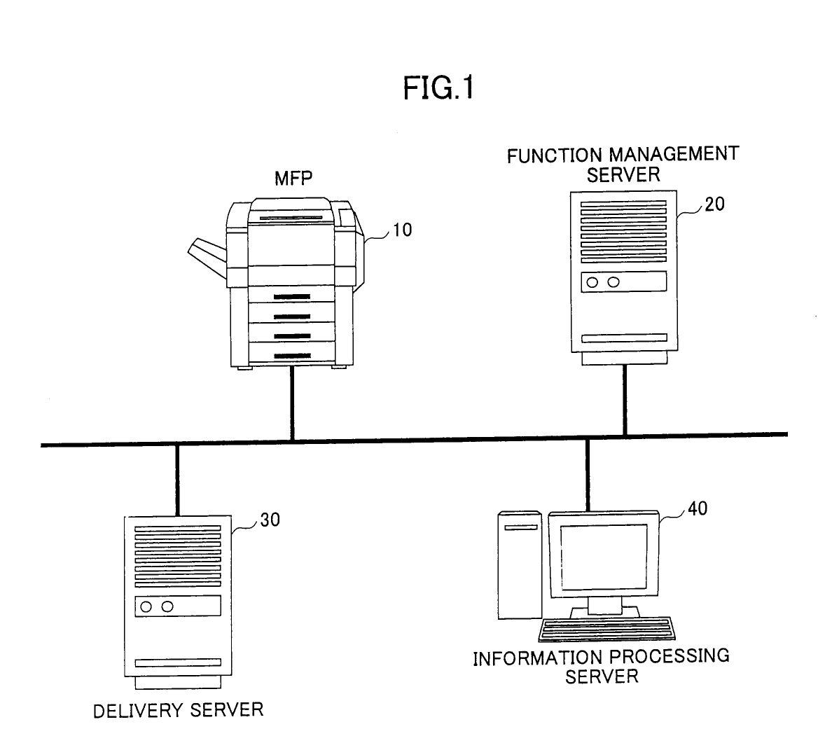

A description is given below, with reference to the FIGS. 1 through 13 of embodiments of the present invention.

Embodiments of an image forming apparatus are described below with reference to the accompanying drawings.

Note that in the following descriptions of the embodiments, a multifunction peripheral having functions of a printer, a scanner, a copier, and a facsimile machine is an example of an image forming apparatus that processes image data; however, the image forming apparatus is not limited to the multifunctional apparatus having these functions.

### First Embodiment

### System and Hardware Configurations

FIG. 1 is a diagram illustrating an operations example in a delivery processing system according to a first embodiment of the invention. As illustrated in FIG. 1, the delivery system includes a multifunction peripheral (MFP) 10, a function management server 20, a delivery server 30, an information processing terminal such as a personal computer (PC) or a personal data assistance (PDA) 40, which are connected via a network. Note that the number of MFPs, the number of servers, and the number of information processing terminals are not limited to those illustrated in FIG. 1. Any number of such apparatuses may be connected via the network.

The MFP 10 is configured to integrate functions of a scanner, a copier, a printer, and a facsimile machine in one enclosure. In the MFP 10, the scanner function scans a paper medium or the like to generate image data and transmits the generated image data to the delivery server 30. Details of the MFP 10 are described later. The MFP 10 is also referred to as an “image forming apparatus” 10 in the following description.

In addition, a control system of the image forming apparatus 10 according the embodiments is composed of a software development kit (SDK), and carries out accumulation or delivery of documents based on the processing flows designed by a user.

The function management server 20 is configured to manage functions of the MFP 10. The function management server 20 manages the functions tailored to users or stores information relating to the users by user authentication. An example of the function management server 20 includes a server or the like that administers user information or logs.

The delivery server 30 is a workstation type computer that receives the image data scanned by the MFP 10 and executes various types of processing or delivery processing based on a specified processing flow (also called as a “project”). Settings of the delivery server 30 include an email transmission, facsimile transmission and folder delivery. The delivery server 30 also handles errors if generated during the delivery processing.

The information processing terminal 40 creates a processing flow by allowing an administrator to initiate a management tool related to data delivery to sequentially select plug-ins of input, image conversion, and output. The created processing flow is stored in the delivery server 30.

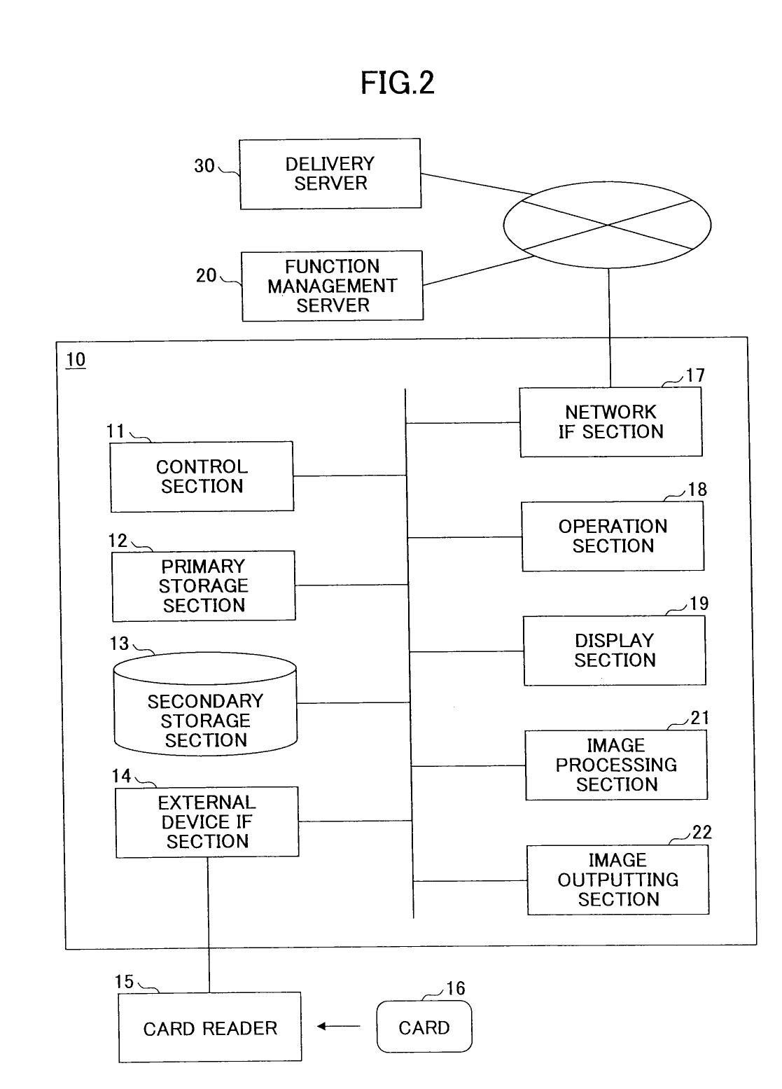

Next, a hardware configuration of the image forming apparatus 10 according to the first embodiment is described. FIG. 2 is a block diagram illustrating a hardware configuration example of the image forming apparatus 10 according to the first embodiment. As illustrated in FIG. 2, the image forming apparatus 10 includes a control section 11, a primary storage section 12, a secondary storage section 13, an external device IF section 14, a network IF section 17, an operations section 18, a display section 19, an image processing section 21, and an image outputting section 22.

The control section 11 functions as a CPU that controls devices or carries out operations or processing of data in the image forming apparatus 10. The control section 11 also executes a computer program stored in the primary storage section 12 to receive data from an input device or a storage device, operate on or process the received data, and output the operated on or processed data to an output device or a storage device.

The primary storage section 12 is a storage device such as a read only memory (ROM) or a random access memory (RAM) that permanently or temporarily stores computer programs or data including basic software of an operating system or application software executed by the control section 11.

The secondary storage section 13 is a storage device such as a Hard disk drive (HDD) that stores data related to application software or the like.

The external device IF section 14 is an interface that connects the image forming apparatus 10 with a card reader that inputs user information for authentication. The external device IF section 14 may be composed of a USB port (USB host interface) or a serial port.

The card reader 15 reads information from cards 16. The card reader 15 also includes a hardware interface such as a USB connecter or a serial interface to connect the card reader 15 with the external device IF section 14. The card reader 15 may also be provided inside the image forming apparatus 10. The card reader 15 may either be a contact type or contactless type.

The cards 16 are not limited to IC cards, but may be any type of a card capable of at least recording a unique card ID (card number) such as a magnetic card. The card ID is generally called a “universal ID” or a “card serial number”. Specific examples of the cards 16 include a proximity card, a Mifare card, and a Java (registered trademark) card.

In the first embodiment, one of the cards 16 is supplied to each user. However, a card 16 may be shared by several users based on the security level required for operation of the image forming apparatus. Note that a user is not limited to one type of the cards 16. As described above, the card reader 15 may simply be connected to the image forming apparatus 10 via the USB. Thus, different card readers 15 corresponding to different types of cards 16 (e.g., proximity card, Mifare card, and Have (registered trademark)) may simultaneously be connected to the image forming apparatus 10. In this case, the different types of the cards 16 may be used simultaneously.

The network IF section 17 is an interface between the function management server 20 and the delivery server 30 that are connected via the network such as a local are network (LAN) or wide area network (WAN) composed of data transmission lines including wires or wireless lines and the image forming apparatus 10.

The operations section 18 includes hardware keys via which a user can input data. The display section 19 includes a liquid crystal display (LCD) on which an operations screen or a message can be displayed. Note that the display section 19 and operations section 18 may be integrated as an operations panel.

The image processing section 21 carries out various types of image processing required for outputting (e.g., printing) image data. The image outputting section 22 carries out outputting image data (e.g., printing).

In FIG. 2, the image forming apparatus 10 is connected to the function management server 20 via the network (wired or wireless). The function management server 20 includes user authentication function that carries out user authentication based on an authentication system using a user ID and a password combination such as a lightweight directory access protocol (LDAP), Windows (registered trademark) authentication, and Kerberos.

That is, the function management server 20 includes a user information database (DB) containing relational information between user IDs and passwords. The function management server 20 matches the relational information recorded in the user information DB with the user ID and password combination to carry out the user authentication. Note that the user ID may generally be called as a “user name” which is user identification information or user information, with which the user can be uniquely identified. Note that the user information includes functional information on the functions tailored to the user or information on a remaining amount of money for the user.

The image forming apparatus 10 is connected to the delivery server 30 via the network. The delivery server 30 administers delivery processing of the image data scanned in the image forming apparatus 10 and includes the user authentication function as described earlier.

### <Functional Configuration>

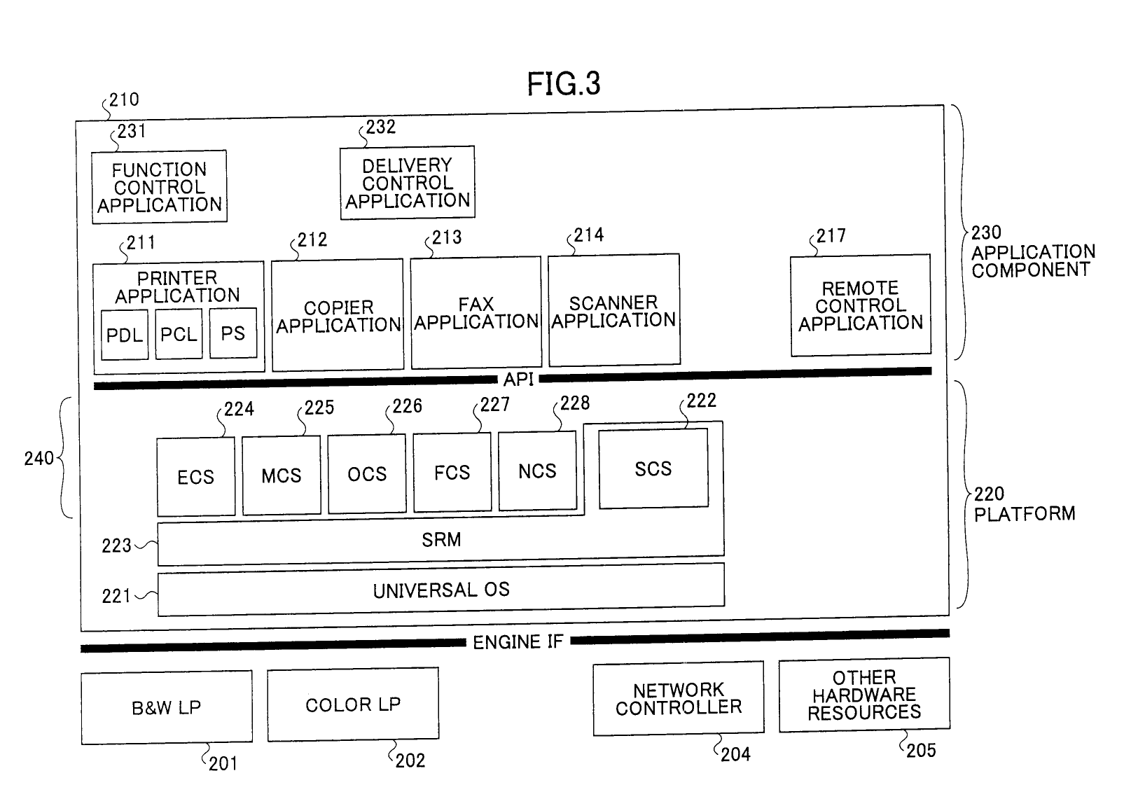

FIG. 3 is a block diagram illustrating a functional configuration example of the image forming apparatus 10 according to the first embodiment of the invention. As illustrated in FIG. 3, the image forming apparatus 10 includes a black-and-white line printer (B&W LP) 201, a color line printer (Color LP) 202, a network controller 204, hardware resources 205 such as facsimile machine and a memory, and a software group 210 including a platform 220 and an application set 230.

The platform 220 includes a control service that translates a processing request from the application set 230 to generate an acquisition request for acquiring hardware resources, a system resource manager (SRM) 223 that manages one or more hardware resources and adjusting the acquisition request from the control service, and a universal OS 221.

A control service layer 240 is formed of plural service modules including a system control service (SCS) 222, an engine control service (ECS) 224, a memory control service (MCS) 225, an operations panel control service (OCS) 226, a facsimile control service (FCS) 227, and a network control service (NCS) 228. Note that the platform 220 includes an API capable of receiving the processing request from the application set 230 based on a predetermined function.

The universal OS 221 may be a universal operating system such as UNIX (registered trademark) that executes software programs of the platform 220 and those of the application set 230 in parallel as separate processes. Note that UNIX (registered trademark) is employed as the universal OS 221 in the first embodiment. Note that the universal OS 221 is not limited to UNIX (registered trademark). Any OS may be employed as the universal OS 221.

The processes of the SRM 223 and SCS 222 control the system and manage the hardware resources. The process of SRM 223 is executed based on the adjustment of the request from a higher layer that utilizes the hardware resources such as an engine, a memory, an HDD file, and a host IO (Centronics IF, network IF, IEEE 1394 IF, RS232C IF, etc.) of the scanner section or printer section.

More specifically, the process of the SRM 223 determines whether the requested hardware resource is available; that is, whether the hardware resource requested has been allocated to other requests. If the requested hardware resource is available, the process of the SRM 223 notifies the higher layer of information indicating that the requested hardware is available. The process of the SRM 223 also schedules a time table to allocate the hardware resources for the requests assigned from the higher layer, and carries out requested operations. That is, the process of the SRM 223 causes the printer engine to convey sheets of paper, form images thereon, secure memory, and generate files.

The process of the SCS 222 carries out processing such as managing the applications, controlling interruption applications, an operations section, a system screen display and an LED display, and managing the resources.

The process of the ECS 224 controls the engine section of the hardware resources 205 including the black-and-white line printer 201, the color line printer 202, and the facsimile machine.

The process of MCS 225 acquires and releases an image memory, utilizes the HDD drive, and compresses image data and decompresses the compressed image data.

The process of the FCS 227 supplies APIs from the application set 5 for carrying out a FAX transmission or its reception via the network such as a PSTN/ISDN, registering or referring to corresponding fax data managed by a backup memory BKM (backup SRAM), reading fax-transmitted data, printing fax-received data, and carrying out integrated transmission and reception.

The process of the NCS 228 provides services that can be shared between the applications that require the network IO. Further, the process of the NCS 228 allocates data received via the network based on protocols to corresponding applications and functions as an intermediary when data are transmitted from the application set 230 to the network side devices. Specifically, the process of the NCS 228 server daemons such as ftpd, lpd, snmpd, telnetd, and smtpd, or client functions for the protocols of the daemons.

The process of the OCS 226 controls an operations panel (i.e., information transmission unit) that communicates information between an operator (user) and the image forming apparatus 10. The OCS 226 includes an OCS process portion that acquires a key event by the depression of a key on the operations panel and transmits a key event function corresponding to the acquired key, and an OCS library portion including a graphic function for outputting various types of screens on the operations panel upon request of the application set 230 or the control service layer 240, and other functions for controlling the operations panel. The OCS library portion is implemented by having links to the respective modules of the application set 230, the control service layer 240, and the later described display processing section. Note that the portions of the OCS 226 may be configured to operate in processes, or may be configured as OCS libraries.

The application set 230 includes a printer application 211 having a page description language (PDL) such as Printer Control Language (PCL) and PostScript (PS), a copier application 212, a facsimile (FAX) application 213, a scanner application 214, and a remote control application 217 that transmits various requests to apparatuses or devices on the network.

The function control application 231 (i.e., first control unit) controls operation of the functions of the image forming apparatus 10 or carries out user authentication when a user desires to execute the functions of the image forming apparatus 10. The delivery control application 232 (i.e., second control unit) controls input processing, image conversion processing, and output processing, or combinations of such types of processing.

Thus, the image forming apparatus 10 according to the first embodiment includes the application set 230 having the plural applications and the control service layer 240 having the plural service modules that are all operated as separate processes. Each of the processes includes one or more threads, which are executed in parallel. The service modules of the control service layer 240 provide service in common between the plural applications of the application set 230. Accordingly, numerous processed and threads cooperatively operate in parallel to provide services to the user for image forming processing such as copying, printing, and transmitting facsimile.

Note that in the image forming apparatus 10 according to the first embodiment, the processes of the plural applications of the application set 230 and the processes of the plural services of the control service layer 240 operate independently. However, a process of the application set 230 may be combined with a process of the control service layer 240 to form a single process. Further, in a case where the image forming apparatus 10 is configured to include no application set 230 but to include the processes of the control service layer 240 and the hardware resources only, a new application may be installed via the network connected to the application set 230 by the NCS 228. In the image forming apparatus 10 configured as above, each of the applications of the application set 230 may be added or deleted per application unit.

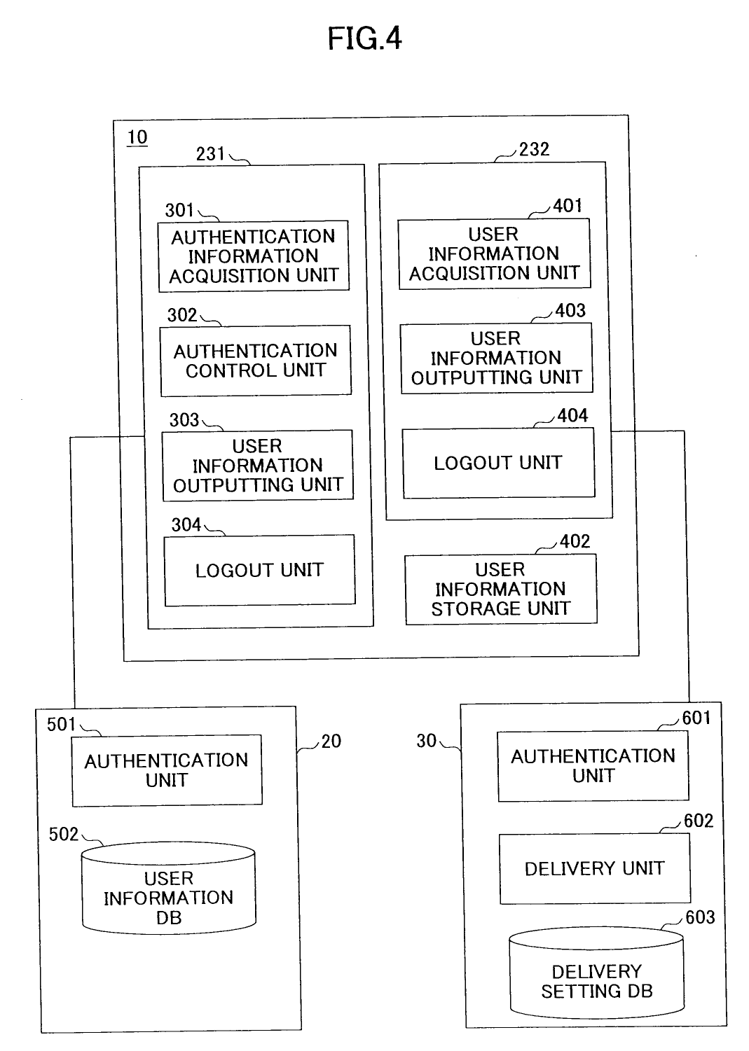

Next, major functions to directly transmit data between the applications that operate in separate processes are described in the first embodiment. FIG. 4 is a block diagram illustrating a functional configuration example of the function management server 230, the delivery server 30, and the image forming apparatus 10 according to the first embodiment.

As illustrated in FIG. 4, the image forming apparatus 10 includes the function control application 231, the delivery control application 232, and the user information storage unit 402. Note that the function control application 231 and the delivery control application 232 may operate in parallel in the separate processes each of which requires user authentication to execute processing.

The function control application 231 includes the authentication information acquisition unit 301, the authentication control unit 302, the user information outputting unit 303, and the logout unit 304. The delivery control application 232 includes the user information acquisition unit 401, the authentication control unit 403, and the logout unit 404. First, user authentication for the function control application 231 (i.e., first user authentication) and user authentication (i.e., second user authentication) for the delivery control application 232 are described.

### (Authentication)

The authentication information acquisition unit 301 acquires, while the display section 16 displays the login screen, the card ID of the card 16 that is read by the card reader 15 when the user sets the card 16 on the card reader 15. Note that setting the card reader 16 on the card reader 15 indicates that the card reader 15 can read information recorded on the card 16. Examples include when the user inserts the card 16 into the card reader 15 and when the user holds the card 16 over the card reader 15.

The authentication information acquisition unit 301 acquires a user ID and a password combination corresponding to the acquired card ID. Hereafter, it is assumed that the image forming apparatus 10 includes the relational information related to card IDs, including user IDs, passwords, card validity, and the like. If there is a password that has not been registered in the relational information, a password prompt screen is displayed on the display section 19 for the user to input the password.

Note that in the first embodiment, the user authentication (i.e., first user authentication) is carried out by acquiring the authentication information from the card 16; however, the user authentication may also be carried out by acquiring biometric information such as fingerprint (biometric authentication) or by acquiring information input by the user.

On receiving the user ID (or card ID) and password combination from the authentication information acquisition unit 301, the authentication control unit 302 transmits the acquired user ID (or card ID) and password combination to the function management server 20. An authentication unit 501 of the function management server 20 carries out user authentication (i.e., first user authentication) using the user ID and password combination transmitted from the image forming apparatus 10.

The authentication unit 501 of the function management server 20 authenticates a user based on the user ID and password combination acquired from the image forming apparatus 10, and a user ID and password combination stored in the user information DB 502 of the function management server 20.

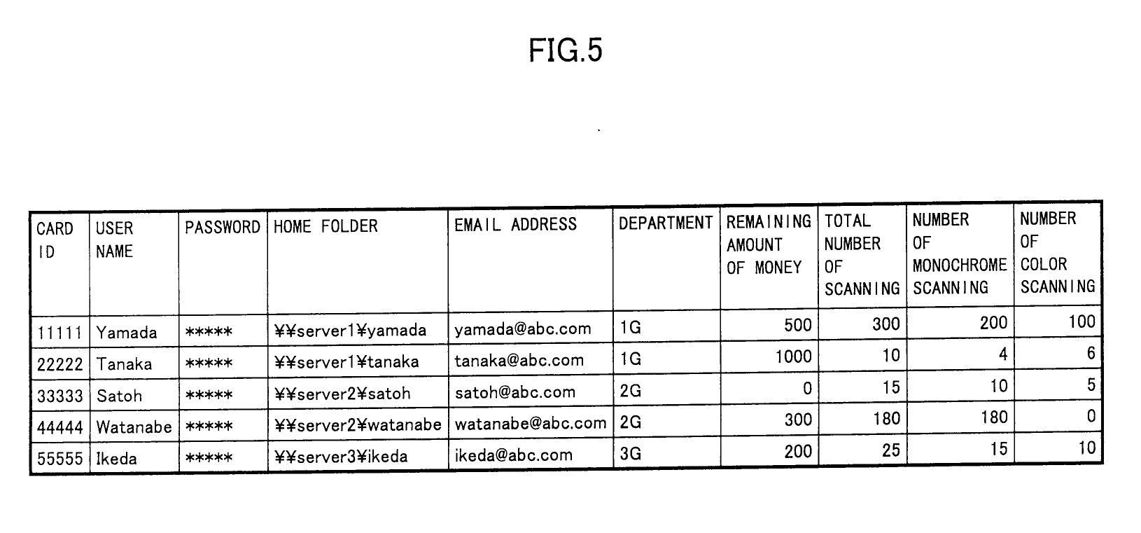

Below, information (user information) stored in the user information DB 502 of the function management server 20 is described. FIG. 5 is a table illustrating an example of the user information. As illustrated in FIG. 5, the user information includes the card IDs, the user IDs, the passwords, Home folders, email addresses, departments, remaining amounts of money, the total numbers of scans, the numbers of monochromatic scans, and the numbers of color scans.

The “Home folder” includes information indicating network paths of the users' home folders. The “remaining amount of money” includes information indicating amounts of money the users have charged. The “total number of scanning”, “number of monochrome scanning”, and “number of color scanning” indicate log information on the number of scannings carried out by the image forming apparatus 10. Note that the user information includes information on authorized functions for each user.

Referring back to FIG. 4, when a user has succeeded in an authentication (i.e., first user authentication), the authentication unit 501 of the function management server 20 transmits the result of the successful authentication and the information on the user who has succeeded in the authentication to the image forming apparatus 10. If the user has failed in the authentication, the authentication unit 501 transmits the result of authentication failure to the image forming apparatus 10.

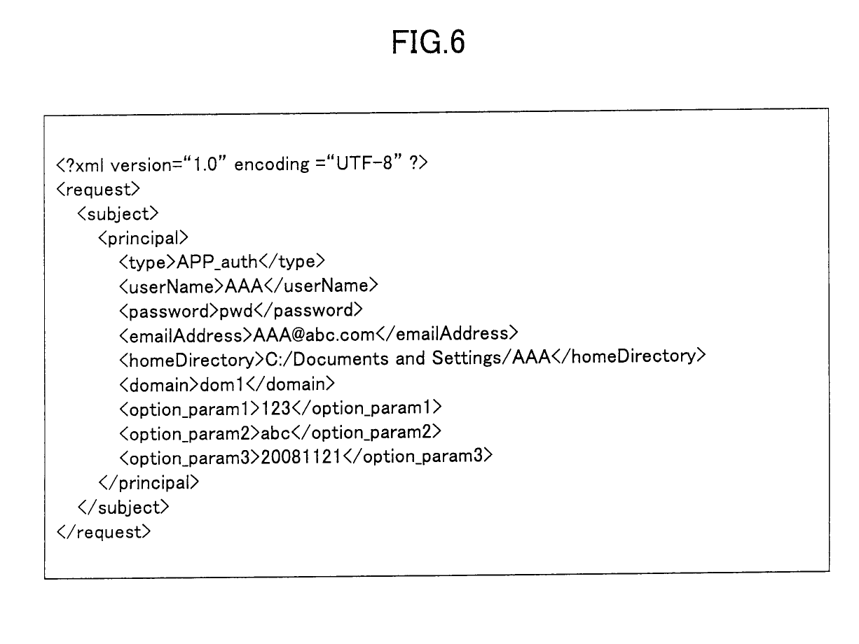

Below, a description of the user information to be transmitted is given. FIG. 6 is a diagram illustrating an example of the user information in an XML format. In the example illustrated in FIG. 6, the user information includes <type>, <userName>, <password>, <emailAddress>, <homeDirectory>, <domain>, and <option>.

A type of an application is assigned to the <type>. Any information may be given to the <option> such as a remaining amount of money.

Referring back to FIG. 4, the authentication control unit 302 receives a response indicating a successful authentication (i.e., first user authentication) from the function management server 20, and outputs, if receiving the user information illustrated in FIG. 6, the user information to the user information outputting unit 303. Note that in this embodiment, the authentication control unit 302 and the user information outputting unit 303 are separately configured for convenience of description; however, they may be integrated in one component. The user information outputting unit 303 outputs the acquired user information to the delivery control application 232.

Next, the user information acquisition unit 401 of the delivery control application 232 acquires the user information from the function control application 231. The user information outputting unit 401 stores the acquired user information in the user information storage unit 402. The user information storage unit 402 is a data storage region in which the user information is stored.

The authentication control unit 403 transmits, if detecting a delivery processing request to the delivery server 30, the user ID and password combination of the user information obtained from the user information storage unit 402 to the delivery server 30.

On receiving the user ID and password combination from the image forming apparatus 10, the authentication unit 601 of the delivery server 30 authenticates the user (i.e., second user authentication) based on the user information and password combination managed by the authentication unit 601 of the delivery server 30 itself. Note that the delivery server 30 may be configured to allow an external authentication server to authenticate a user.

The authentication unit 601 transmits, if the user authentication (i.e., second user authentication) is successful, the process flow (project) information that can be accessed by the authenticated user to the image forming apparatus 10. The authentication unit 601 transmits, if the user authentication has failed, a request to display an authentication screen on the display section 19 of the image forming apparatus 10.

Thus, the function control application 232 can carryout user authentication based on the user ID and password combination of the user who has succeeded in the user authorization for the function control application 231. That is, the user authentication may not have to be carried out for both the function control application 231 and the delivery control application 232 that operate in the separate processes. This configuration is based upon the idea that if users of the function control application 231 and the delivery control application 232 are identical, the same user ID and password combination may be used in the user authentication for the function control application 231 (i.e., first user authentication) and the user authentication for the delivery control application 232 (i.e., second user authentication). If the passwords are different between the function control application 231 and the delivery control application 232, the user authentication for the function control application 231 and that for the delivery control application 232 may be carried out separately as they have been carried out in the conventional manner.

Accordingly, if the user authentication is carried out once when the user executes the function control application 231, the subsequent user authentication for the delivery control application 232 is carried out within the same image forming apparatus 10. As a result, the user may not have to input the password again via the authentication screen of the display section 19. That is, authentication by single sign-on may be realized if a destination for the data received from the application developed by the third party vendor is disclosed.

### (Logout)

Next, logging out from the function control application 231 and that from the delivery control application 232 are described. The relationship in the logging out between the applications is described. The user who has logged in to the functional control application 231 and subsequently logged in to the delivery control application 232 will not be able to log out from the function control application 231 unless the user has logged out from the delivery control application 232. In this manner, the function control application 231 and the delivery control application 232 may not be accessed by different users. That is, if the user of the function control application 231 has initially logged out, a subsequent user who logs in to the function control application 231 may be able to execute the delivery control application 232 using the third person's ID and password combination. Accordingly, it is necessary to prevent simultaneous access to the function control application 231 and the delivery control application 232 by different users.

The user can, on the other hand, can log out of the delivery control application 232 independently of the function control application 231. This is because the user cannot be logged in to the delivery control application 232 unless the same user has been logged in to the function control application 231. That is, even if the user has been logged out of the delivery control application 232, the function control application 231 and the delivery control application 232 may not be accessed by different users.

Hereinafter, two types of logout processes, namely, a forced logout and a logout request are described based on the logout relationships between the applications. The “login mode” is defined by a process in which the user who has logged in to the delivery control application 232 operates the operations panel (specifying the delivery addresses or reading conditions) or a process in which the user who has logged in to the delivery control application 232 operates nothing. The login mode may also be simply called “login”.

The “delivery processing mode” is defined as a process in which the user who has logged in to the delivery control application 232 waits for data to be read from a paper medium, creates image data from the read data, transmits the image data to the delivery control application 232, or waits for the image forming apparatus that is carrying out the processing (the user has no control to stop the processing).

The “forced logout” is an instruction to forcefully log out the user who has logged in to the delivery control application 232 and is in the login mode from the delivery control application 232. Note that the “forced logout” will fail in a case where the user is in the “delivery processing mode”.

The “logout request” is an instruction to query whether there is any user who is in a “login mode”. If there is no user in the “login mode” (e.g., in cases where a user has never used the delivery control application 232, where a user has explicitly logged out from the delivery control application 232, and where a user is automatically logged out from the delivery control application 232 due to time out of the delivery control application 232), the logout results in success. By contrast, if the delivery control application 232 shows the “login mode”, the logout results in failure.

### (1) Forced Logout

(In a Case where a User is Required to Precedingly Log Out from the Functional Control Application 231)

On detecting depression of a logout button displayed on the display section 19, the logout unit 304 of the function control application 231 generates an instruction “forced logout” to the delivery control application 232. Unless the delivery control application is in a “delivery processing mode”, the logout unit 404 of the delivery control application 232 logs out the user who has been in the login mode in the delivery control application 232. Then, the user information is deleted from the user information storage unit 402. The user information is deleted from the user storage unit 402 so that the user information cannot be used by another user who subsequently logs in to the function control application 231. After having deleted the user information and logged out the user from the delivery control application 232, the logout unit 304 logs out the user who has been logged in to the function control application 231.

By contrast, if the delivery control application 232 is in the “delivery processing mode”, the user log out from the delivery control application 232 fails. Next, the logout unit 304 repeatedly generates the “forced logout” instruction at regular intervals until the delivery processing of the delivery control application 232 completes. When the delivery processing of the delivery control application 232 has completed, the function control application 231 and the delivery control application 232 carry out the processing to log out the user.

(In a Case where a User is Required to Precedingly Log Out from the Delivery Control Application 232)

On detecting depression of the logout button displayed on the display section 19, the logout unit 404 of the function control application 232 determines whether the function control application 232 is in the “delivery processing mode”. Unless the delivery control application 232 is in the “delivery processing mode”, the logout unit 404 of the delivery control application 232 logs out the user who has been logged in to the delivery control application 232. However, the user information is not deleted from the user information storage unit 402. The user information is not deleted from the user information storage unit 402 because the same user may execute the delivery processing again.

If the delivery control application 232 is in the “delivery processing mode”, the logout unit 404 of the delivery control application 232 waits for the delivery processing to complete and logs out the user who has been logged in to the delivery control application 232.

As another example, the “forced logout” may be carried out when a remaining amount of money of the user is reduced to zero. That is, when the remaining amount of money of the user is reduced to zero while the delivery control application 232 is in the delivery processing mode, the logout unit 404 of the delivery control application 232 logs out the user who has been logged in to the delivery control application 232.

Which one of the function control application 231 and the delivery control application 232 the user is to be logged out from is determined based on which one of the function control application 231 and the delivery control application 232 is being executed at the time the user depresses the logout button. Specifically, when the user depresses the logout button via the operations screen while the function control application 231 carries out functions such as photocopying or printing, the user is determined to be logged out from the function control application 231.

Likewise, when the user depresses the logout button via the operations screen while the delivery control application 232 carries out the delivery processing based on the processing flow, the user is determined to be logged out from the delivery control application 232.

### (2) Logout Request

(In a Case where the Functional Control Application 231 Precedingly Results in a Time Out)

The logout unit 304 of the function control application 231 transmits the “logout request” to the delivery control application 232 if none of the functions of the function control application 231 is executed for a predetermined time. Note that the function control application 231 has a timer function and thus is capable of measuring a time period in which none of the functions such as photocopying has been in operation by decrementing the count of the timer function.

If there are no other users who are in the “login mode” in the delivery control application 232, the logout unit 404 of the delivery control application 232 logs out the user who has been logged into the delivery control application 232.

Then, the user information is deleted from a user storage unit 402. The user information is deleted from the user storage unit 402 so that the user information cannot be used by another user who subsequently logs in to the function control application 231. After having deleted the user information and logged out the user from the delivery control application 232, the logout unit 304 logs out the user who has been logged in to the function control application 231.

By contrast, if there is a user who is “login mode”, the user log out from the delivery control application 232 fails. Then, the logout unit 304 resets the counter of the timer to the initial value and start decrementing the count.

(In a Case where the Delivery Control Application 232 Precedingly Results in a Time Out)

If none of the functions of the delivery control application 232 is executed for a certain period of time, the logout unit 404 of the delivery control application 232 logs out the user who has been logged in to the delivery control application 232. However, the user information is not deleted from the user information storage unit 402. Note that the function control application 232 has a timer function and thus is capable of measuring a time period in which no delivery processing is being carried out by decrementing the count of the timer function.

Thereafter, if the logout is required for the function control application 231 (i.e., if a user is required to log out from the function control application 231, the logout unit 304 of the function control application 231 generates the “forced logout” instruction and transmits it to the delivery control application 232. The logout unit 304 of the function control application 231 generates the “forced logout” instruction, so that the user information is deleted from the user storage unit 402. After having deleted the user information, the logout unit 304 of the function control application 231 logs out the user who has been logged in to the function control application 231.

Accordingly, the function control application 231 waits for the user to log out from the delivery control application 232 so as to log out the user from the function control application 231. As a result, the function control application 231 and the delivery control application 232 may not be operated by different users.

### <Operations Screen Transitions>

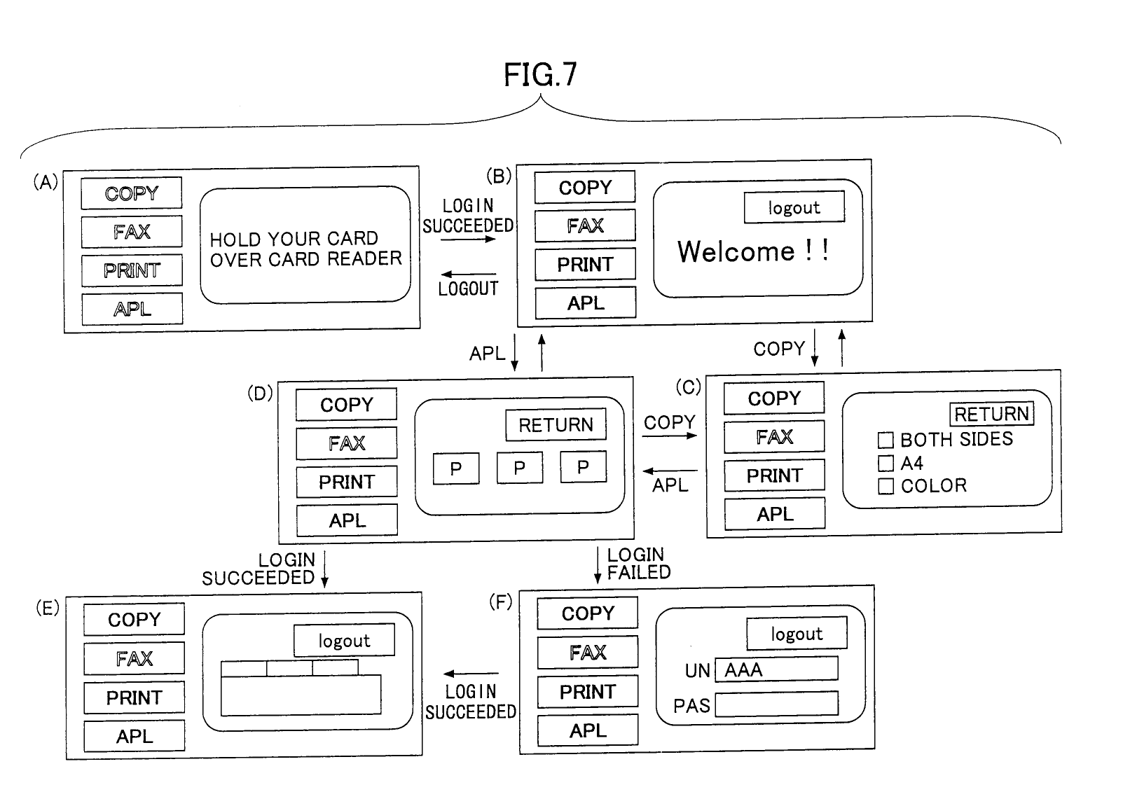

Next, examples of operations screen transitions are described. FIG. 7 is a diagram illustrating a transition example of an operations screen of the image forming apparatus (MFP). As illustrated, “hold your IC card over the card reader” is displayed on an operations screen (A) of FIG. 7 for authenticating a user of the function control application 231. Then, the functions of the function control application 231 such as “copy” or “print” are displayed at half-luminance so that a user cannot perform processing. These functions are not operable unless a user succeeds in user authentication.

Next, when the user holds his or her IC card over the card reader and succeeds in user authentication, the operations screen (A) of FIG. 7 is changed to an operations screen (B) of FIG. 7. After a successful user authentication, the functions of the function control application 231 that the login user can operate are displayed at full-luminance so that the user can execute the functions displayed on the operations screen (B) of FIG. 7 such as “copy”, “print”, and “APL”. The “APL” indicates an extended application that can carry out the delivery processing by the delivery server 30.

Next, when a “copy” button is depressed via the operations screen (B), the operations screen (B) of FIG. 7 is changed to an operations screen (C) of FIG. 7. The “copy” function displayed on the operations screen (C) of FIG. 7. The operations screens (A) through (C) of FIG. 7 are controlled by the function control application 231.

Next, when an “APL” button is depressed via the operations screen (B) or the operations screen (C) of FIG. 7, the operations screen (B) or the operations screen (C) of FIG. 7 is changed to the operations screen (D) of FIG. 7. A list of projects in the processing flow is displayed on the operations screen (D) of FIG. 7. In this example, a project is indicated by “P”. Note that a “RETURN” button displayed on the operations screens (C) or (D) of FIG. 7 is provided for returning to the operations screen (B) of FIG. 7.

Next, when “P” is depressed via the operations screen (C) of FIG. 7, user authentication is carried out using the user ID and password combination stored in the user information storage unit 403. If the authentication succeeds in the delivery server 30, the operations screen (C) is changed to an operations screen (E) of FIG. 7. Since this processing is internally carried out, the user is unaware of the fact that the user authentication has been carried out. As illustrated in (E) of FIG. 7, the user checks a setting value of each processing of the processing flow to execute the delivery processing based on the processing flow.

Next, when a “P” button is depressed via the operations screen (C) of FIG. 7, and the user authentication results in failure, the operations screen (C) of FIG. 7 is changed to an operations screen (F) of FIG. 7. In this example of (F) of FIG. 7, a user name (UN) is already input and displayed at half-luminance, so that the user authentication is carried out by inputting only a password.

If the user authentication is successful via the operations screen (F) of FIG. 7, the operations screen (F) is changed to the operations screen (E) of FIG. 7. Next, when a “copy” button is depressed via the operations screen (D) of FIG. 7, the operations screen (D) of FIG. 7 is changed to the operations screen (C) of FIG. 7. The operations screens (D) through (F) of FIG. 7 are controlled by the delivery control application 232.

### <Processing Flow>

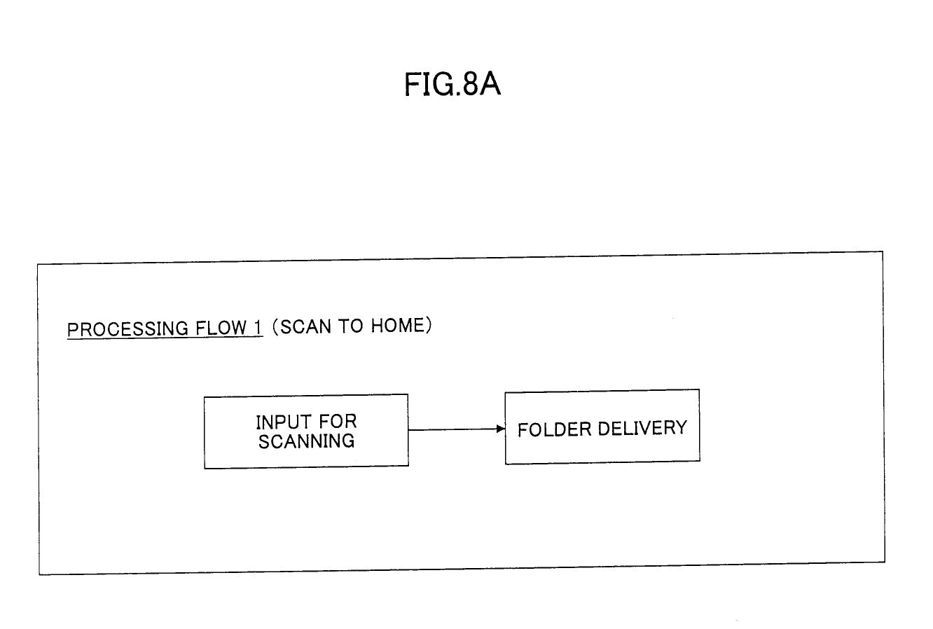

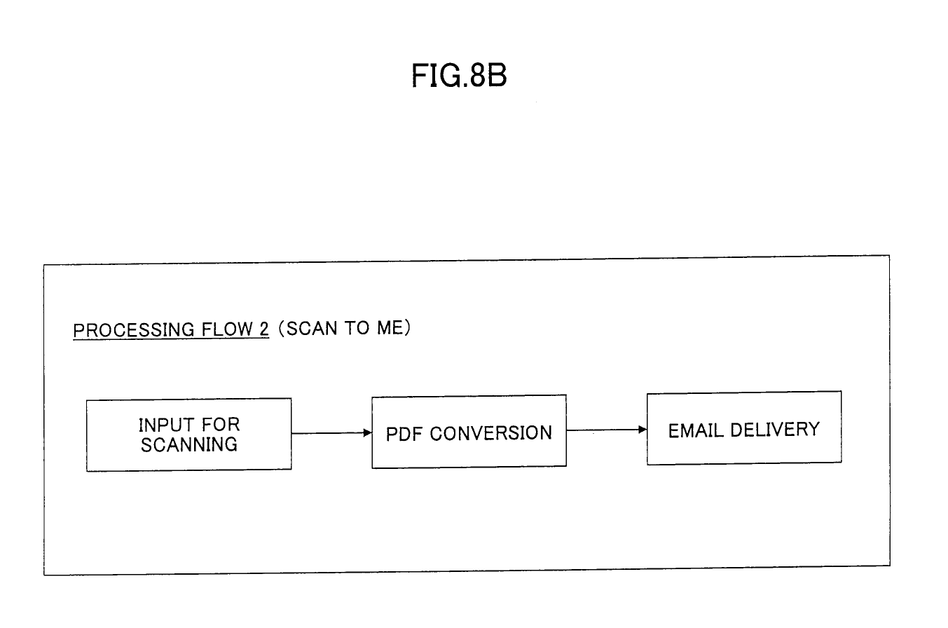

Next, the processing flow utilized by the delivery control application 232 is described. FIGS. 8A and 8B are diagrams illustrating examples of a processing flow according to the first embodiment. As illustrated in FIGS. 8A and 8B, a processing flow 1 (Scan to home) indicates processing in which an original document is scanned to be input as image data, and the input image data are delivered to a folder. Likewise, a processing flow 2 (Scan to me) indicates processing in which an original document is scanned to be input as image data, and the input image data are converted into PDF image data, which are attached to an email to be delivered.

In this process, the setting value of the processing in the processing flow can be automatically set using the user information stored in the user information storage unit 402. For example, the user information includes mail addresses or home directories of the users as illustrated in FIG. 6.

If the delivery processing of the process flow 1 is carried out, the home directory included in the user information stored in the user information storage unit 402 can be set without the user's operation of setting the directories. Likewise, if the delivery processing of the process flow 2 is carried out, the email address included in the user information stored in the user information storage unit 402 can be automatically set without the user's operation of inputting or selecting email addresses.

The processing flows set as described above are delivered by a delivery unit 602 of the delivery server 30. Note that a delivery setting DB 603 of the delivery server 30 contains plugs-in the each processing flows or the processings set by the administrator.

Accordingly, the setting value of the processings in the processing flows can be automatically set without the user's operation of input or selection, using the user information stored in the user information storage unit 402.

### <Operation>

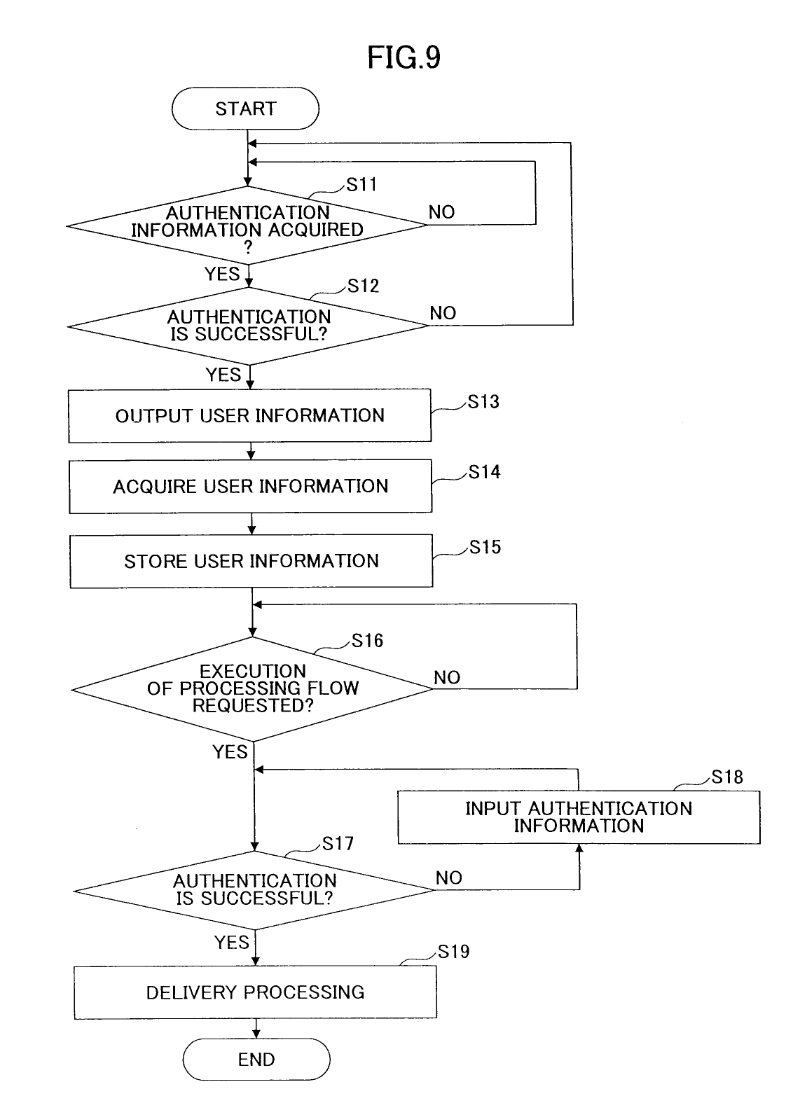

Next, operations of the image forming apparatus 10 according to the first embodiment are described. FIG. 9 is a flowchart illustrating an example of login processing according to the first embodiment. As illustrated in FIG. 9, the authentication information acquisition unit 301 acquires a card ID from an IC card or the like, and a user ID and a password corresponding to the card ID in step S11. Note that biometric authentication using such as a fingerprint or information manually input by a user may also be used for authentication other than the IC card. The authentication information acquisition unit 301 outputs the information acquired by the authentication control unit 302.

In step S12, the authentication control unit 302 transmits information used for the acquired authentication such as a user ID or card ID, and a password to the function management server 20. The function management server 20 authenticates a user and transmits the authentication result to the authentication control unit 302. If the authentication is successful, the function management server 20 transmits the user information of the authenticated user to the image forming apparatus 10.

Further, in step S12, the authentication control unit 302 determines whether the authentication is successful. If the determination result is YES (successful authentication) in step S12, the process goes to step S13, whereas if the determination result is NO (unsuccessful authentication) in step S12, the process returns to step S11.

In step S13, the user information outputting unit 303 outputs the user information acquired from the function management server 20 to the delivery control application 232.

In step S14, the user information acquisition unit 401 of the delivery control application 232 acquires the user information from the function control application 231.

In step S15, the user information acquisition unit 401 outputs the acquired user information to the user information storage unit 402, so that the user information storage unit 402 stores the received user information.

In step S16, the delivery control application 232 determines whether execution of the processing flow is requested. The delivery control application 232 determines that the execution of the processing flow is requested when the “P” displayed on the operations screen (D) of FIG. 7 is depressed. If the determination result is YES (requested) in step S16, the process goes to step S17, whereas if the determination result is NO (not requested) in step S16, the process returns to step S16.

In step S17, the authentication control unit 403 of the delivery control application 232 transmits the user ID and password combination of the user information stored in the user information storage unit 402 to the delivery server 30. The authentication unit 601 of the delivery server 30 authenticates a user using the received user ID and password combination. The authentication unit 601 transmits the authentication result to the delivery control application 232. The authentication control unit 403 receives the authentication result from the delivery server 30 and determines whether the authentication is successful. If the determination result is YES (successful authentication) in step S17, the process goes to step S19, whereas if the determination result is NO (unsuccessful authentication) in step S17, the process goes to step S18.

In step S18, the authentication control unit 403 causes the display section 19 to display an authentication screen (F) of FIG. 7 so that the user inputs his or her password. When the password is input by the user, the process returns to step S17 to authenticate the user again.

In step S19, when the user depresses an execution button of the processing flow, the delivery control application 232 transmits information on the image data or processing flows and bibliographical information on the processing of the processing flow to the delivery server 30. The delivery unit 602 of the delivery server 30 delivers (delivery processing) the image data acquired from the image forming apparatus 10 based on the processing flow.

Accordingly, once the user has been authenticated by the user authentication when the user executes the function control application 231, the subsequent user authentication required for the delivery control application 232 is internally carried out in the same system. As a result, the user may not have to input the password again via the authentication screen.

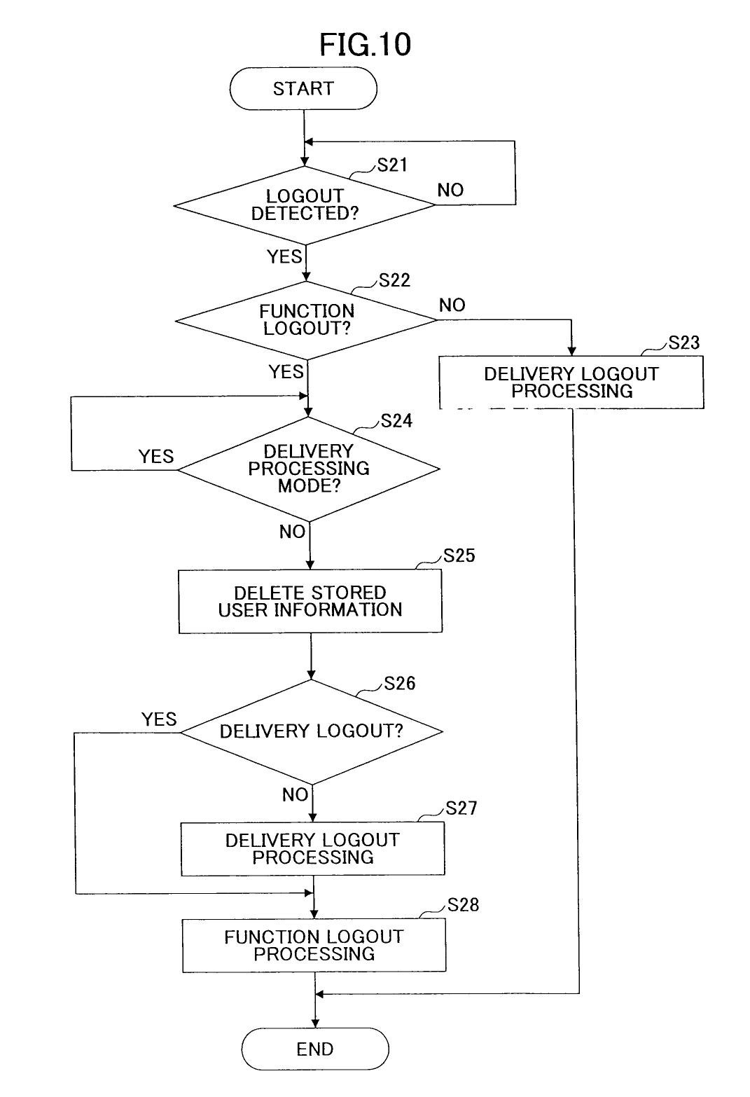

Next, logout processing operations of the image forming apparatus 10 according to the first embodiment are described. FIG. 10 is a flowchart illustrating an example of login processing according to the first embodiment. As illustrated in FIG. 10, in step S21, the logout unit 304 or the logout unit 404 determines whether a logout event is detected. If the determination result is YES (detected) in step S21, the process goes to step S22, whereas if the determination result is NO (not detected) in step S21, the process returns to step S21.

In step S22, the image forming apparatus 10 determines whether the user has logged out from the function control application 231 (also called a “function logout”) or the delivery control application 232 (also called a “delivery logout”). If the determination result is YES (function logout) in step S22, the process goes to step S24, whereas if the determination result is NO (delivery logout) in step S22, the process goes to step S23.

In step S23, the logout unit 404 of the delivery control application 232 logs out the user who has logged in to the delivery control application 232.

In step S24, the logout unit 304 of the function control application 231 queries the delivery control application 232 as to whether the delivery control application 232 is in the delivery processing mode. If the query result is YES (in delivery processing mode) in step S24, the process returns to step S24 and makes the same query again, whereas if the determination result is NO (not in delivery processing mode) in step S24, the process goes to step S25.

In step S25, if the logout event is generated by the function control application 231, the logout unit 404 of the delivery control application 232 deletes the user information stored in the user information storage unit 402.

In step S26, the delivery control application 232 determines whether execution of the processing flow is requested. If the determination result is YES (delivery logout carried out) in step S26, the process goes to step S28, whereas if the determination result is NO (delivery logout not carried out) in step S26, the process goes to step S27.

In step S27, the logout unit 404 of the delivery control application 232 logs out the user who has logged in to the delivery control application 232.

In step S28, the logout unit 304 of the function control application 231 logs out the user who has logged in to the function control application 231.

Accordingly, the function control application 231 waits for the user to log out from the delivery control application 232 so as to log out the user from the function control application 231. As a result, the function control application 231 and the delivery control application 232 may not be operated by different users.

According to the first embodiment, information can be directly transmitted between the applications that operate in separate processes in the same apparatus.

### Second Embodiment

An image forming apparatus 50 according to a second embodiment is described below. The second embodiment provides a case where a certain amount of money is charged every time the delivery processing is carried out via the delivery server. Accordingly, information on a remaining amount of money is added to the user information so as to carry out the delivery processing using the information on the remaining amount of money.

### <Functional Configuration>

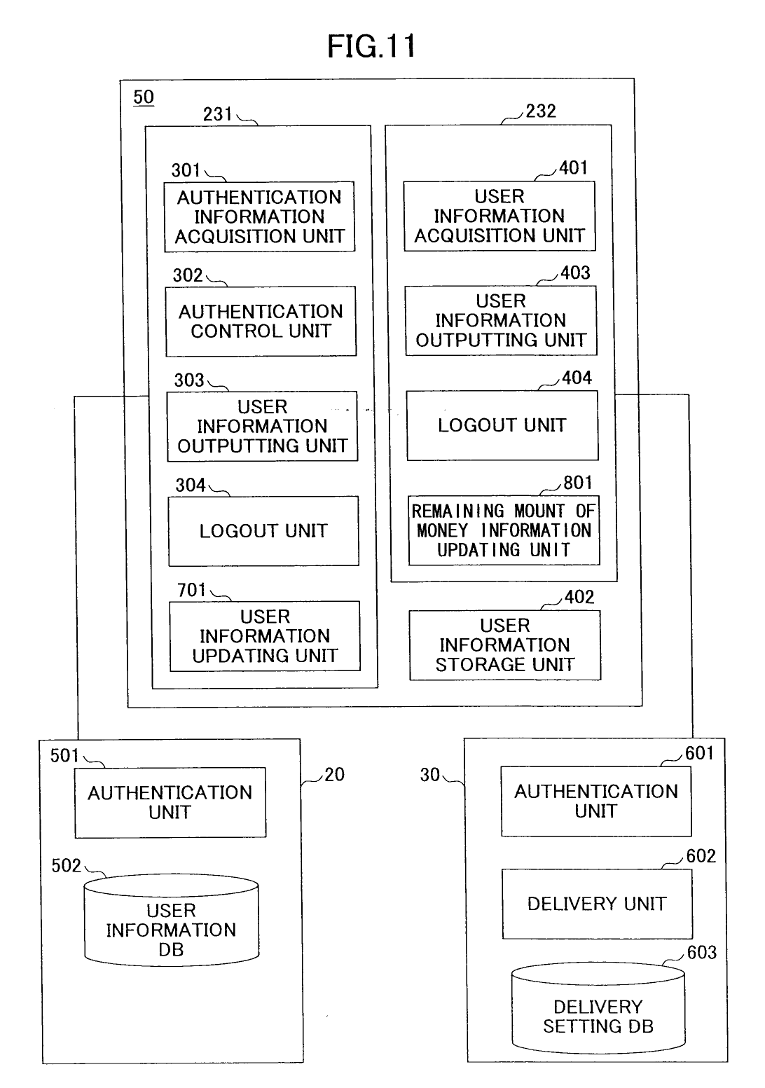

FIG. 11 is a block diagram illustrating a functional configuration example of the function management server 20, the delivery server 30, and the image forming apparatus (MFP) 50 according to the second embodiment. In the functions illustrated in FIG. 11, the functions similar to those illustrated in FIG. 4 are provided with the same reference numerals and the descriptions thereof are omitted.

In the image forming apparatus 50 illustrated in FIG. 11, a user information updating unit 701 is added to the function control application 231, a remaining mount of money information updating unit 801 is added to the delivery control application 232.

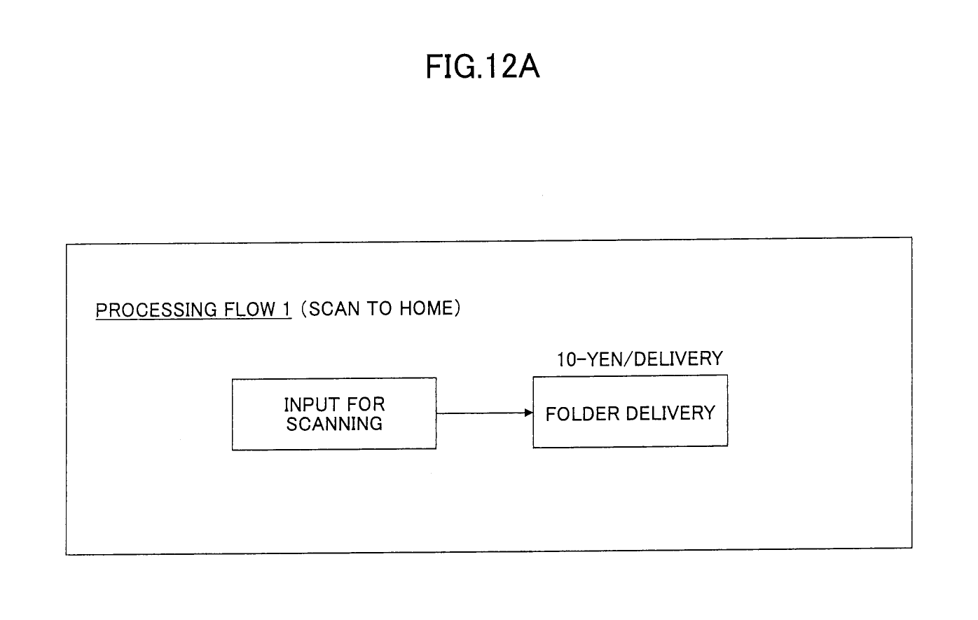

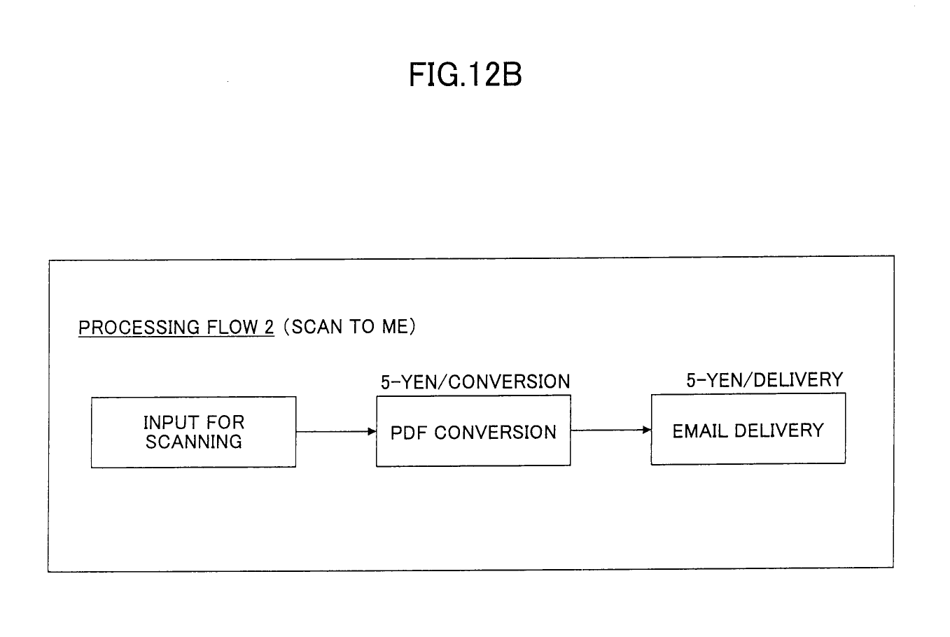

In the second embodiment, a certain amount of money is charged every time the delivery processing is carried out via the delivery server 30. FIGS. 12A and 12B are diagrams illustrating examples of a processing flow according to the second embodiment. As illustrated in FIG. 12A, 10-yen is charged every time a folder delivery is carried out in a processing flow 1 (scan to home). As illustrated in FIG. 12B, 5-yen is charged every time a PDF conversion is carried out, and 5-yen is also charged every time an email delivery is carried out in a processing flow 2 (scan to me).

If a certain amount of money is charged every time the delivery processing is carried out, the amount of money is charged based on the remaining amount of money information contained in the user information stored in the user information storage unit 401. The user information transmitted from the function management server 20 contains the remaining amount of money information.

When the delivery control application 232 requests the delivery server 30 to carrying out the delivery processing, the remaining mount of money information updating unit 801 of the delivery control application 232 verifies the remaining amount of money information of the user information stored in the user information storage unit 402. If the remaining mount of money information updating unit 801 verifies that there is a sufficient remaining amount of money, the remaining mount of money information updating unit 801 accepts the delivery processing request and updates the remaining amount of money information. If, on the other hand, the remaining mount of money information updating unit 801 verifies that there is an insufficient remaining amount of money, the remaining mount of money information updating unit 801 stops the delivery processing request and displays a prompt screen for a user to charge or increase the remaining amount of money or logs out the user from the delivery control application 232.

When the user is logged out from the function control application 231, the user information updating unit 701 of the function control application 231 acquires the remaining amount of money information of the user information before the user information is deleted from the user information storage unit 402.

Next, the user information updating unit 701 transmits the acquired remaining amount of money information with the user ID to the function management server 20. The function management control 20 updates the remaining amount of money information stored in the user information DB 502 corresponding to the user ID acquired from the image forming apparatus 50 with the remaining amount of money information acquired from the image forming apparatus 50.

Accordingly, a certain amount of money can be charged for the delivery processing based on the remaining amount of money information of the user managed by the function management server 20. In addition, when money is charged for the delivery processing, the remaining amount of money information managed by the function management server 20 can be updated. Accordingly, the function control application 231 and the delivery control application 232 may not have to manage the remaining amount of money information.

### <Operation>

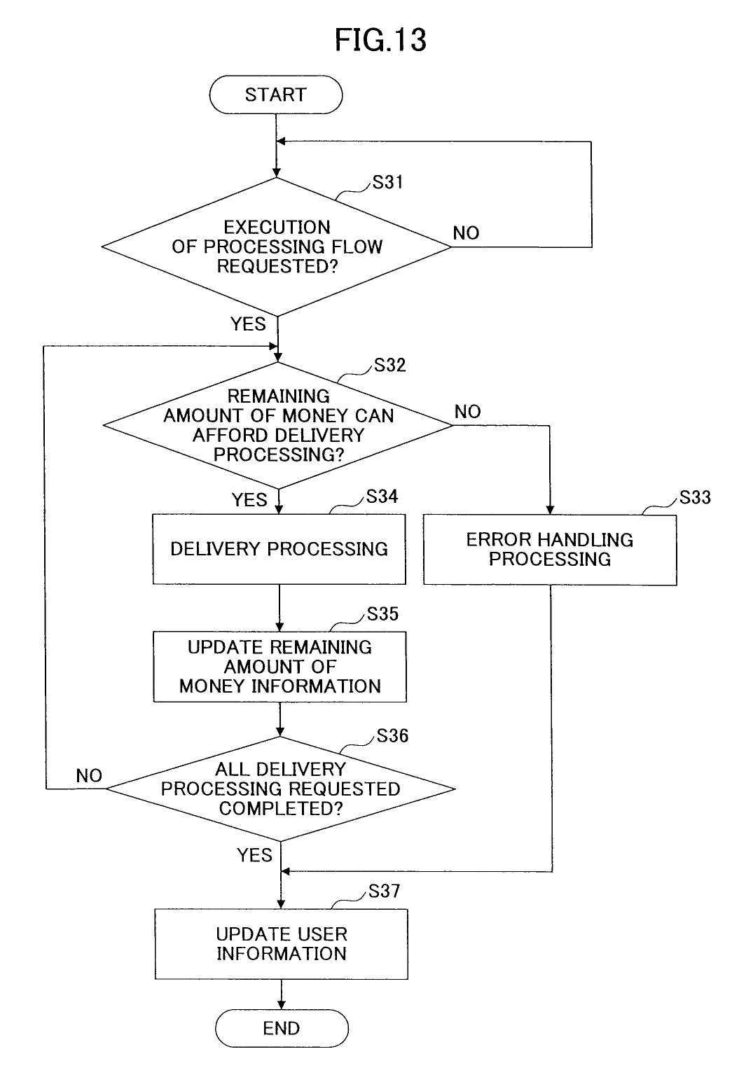

Next, charging operations of the image forming apparatus 50 according to the second embodiment are described. FIG. 13 is a flowchart illustrating an example of money-charging processing according to the second embodiment. As illustrated in FIG. 13, in step S31, the delivery control application 232 determines whether execution of the processing flow is requested. If the determination result is YES (requested) in step S31, the process goes to step S32, whereas if the determination result is NO (not requested) in step S31, the process returns to step S31.

In step S32, the remaining mount of money information updating unit 801 determines whether a remaining amount of money is sufficient for the requested delivery processing. The remaining amount of money information used for the above determination indicates the remaining amount of money information of the user information stored in the user information storage unit 402. If the determination result is YES (sufficient for delivery processing) in step S32, the process goes to step S34, whereas if the determination result is NO (insufficient for delivery processing) in step S32, the process goes to step S33.

In step S33, the remaining amount of money information updating unit 801 carries out error handling processing. The error handling processing includes using a screen of the display section 19 to notify a user of insufficient remaining money, or logging out the user who has been logged in to the delivery control application 232.

In step S34, if it is determined that the remaining amount of money is sufficient for the delivery processing, the delivery control application 232 requests the delivery server 30 to carry out the delivery processing requested by the user. The delivery unit 602 of the delivery server 30 carries out the delivery processing requested by the delivery control application 232.

In step S35, the remaining mount of money information updating unit 801 updates the remaining amount of money information by subtracting the amount of money required (charged) for the requested delivery processing from the remaining amount of money information stored in the user information storage unit 402.

In step S36, the delivery control application 232 determines whether all the delivery processing requested have been completed. If the determination result is YES (completed) in step S36, the process goes to step S37, whereas if the determination result is NO (not completed) in step S36, the process returns to step S32.

In step 37, the user information update unit 701 of the function control application 231 acquires the remaining amount of money information stored in the user information storage unit 402 and transmits the acquired remaining amount of money information with the user ID to the function management server 20 at the same time as the function control application 231 logs out the user. The function management server 20 updates the remaining amount of money information stored in the user information DB 502 corresponding to the user ID acquired from the function control application 231 with the remaining amount of money information acquired from the function control application 231.

Accordingly, a certain amount of money can be charged for the delivery processing based on the remaining amount of money information of the user managed by the function management server 20. In addition, when money is charged for the delivery processing, the remaining amount of money information managed by the function management server 20 can be updated.

### <Modification>

Next, modification of the first and second embodiments is described. In the modifications, the image forming apparatus incorporates the delivery server 30. Functions of the image forming apparatus incorporating the delivery server 30 are basically identical to those of the image forming apparatuses 10 and 50 and the delivery server 30 illustrated in FIGS. 4 and 11. With this modification, the image forming apparatus alone can carry out the types of processing described in the first and second embodiments.

Note that inter-application cooperative programs to be executed in the image forming apparatus according to the first and second embodiments and the modification are provided as installable or executable formatted files recorded on a computer-readable recording medium such as a CD-ROM, flexible disk (FD), CD-R, and DVD (Digital Versatile Disk).

Alternatively, the inter-application cooperative programs to be executed in the image forming apparatus according to the first and second embodiments and the modification may be stored in a computer connected via the network and downloaded from the computer via a network. Further, the inter-application cooperative programs to be executed in the image forming apparatus according to the first and second embodiments and the modification may be distributed or downloaded via a network such as the Internet.

Moreover, the inter-application cooperative programs to be executed in the image forming apparatus according to the first and second embodiments and the modification may be embedded in a ROM.

The inter-application cooperative programs to be executed in the image forming apparatus according to the first and second embodiments and the modification are formed of modules including the aforementioned units recorded on the computer-readable medium which. The units of modules are, when retrieved from the computer-readable recording medium and executed by a processor, loaded in the main memory.

The authentications performed by the function management server 20 and delivery server 30 may be performed by an externally provided authentication server.

The embodiments of the present invention provide an image forming apparatus, a delivery processing system, an image processing method, a computer program thereof, and a recording medium having such a computer program capable of directly transferring information between applications operating in separate processes.

Further, the image forming apparatus, the delivery processing system, and the image processing method according to the present embodiments may be implemented by a computer executable program, or by causing a computer to read such a computer program recorded on a recording medium to execute the computer program.

It should be noted that the invention is not limited by the above embodiments. Various changes and alterations may be made to elements based on the applications of the embodiments without departing from the scope of the invention. In addition, various inventions may be made by appropriate combinations of the elements disclosed in the embodiments. For example, some of the elements disclosed in the embodiments may be eliminated from the combinations. Further, the elements disclosed in the different embodiments may be appropriately combined. Accordingly, the embodiments of the invention are not limited by the specific disclosure above, but rather should be limited only by the scope of the appended claims and their legal equivalents.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that various changes, substitutions, and alterations could be made without departing from the spirit and scope of the invention.

This patent application is based on Japanese Priority Patent Application No. 2009-042881 filed on Feb. 25, 2009, the entire contents of which are hereby incorporated herein by reference.

What is claimed is:

1. An image forming apparatus comprising:
a first control unit configured to control functions of the image forming apparatus and include an output unit configured to output, provided that a first user authentication is successful, a first user information including a first user identification information and password combination; and
a second control unit configured to control an execution of a processing flow composed of types of processing related to an image data delivery and include an acquisition unit configured to acquire the first user information including the first user identification information and password combination output from the first control unit and store the first user information including the first user identification information and password combination acquired from the first control unit as a second user information including a second user identification information and password combination in a storage unit, and an authentication control unit configured to control a second user authentication based on the second user identification information and password combination of the second user information stored in the storage unit,
wherein the first and the second control units operate in separate processes and respectively carry out the first and second user authentications.

2. The image forming apparatus as claimed in claim 1,
wherein the first user information further includes one of a first email address of a user and a first home folder of the user to be stored as a second email address of the user and a second home folder of the user of the second user information in the storage unit, and
wherein the second control unit sets one of the second email address of the user and the second home folder of the user of the second user information stored in the storage unit as a delivery destination of the processing flow and requests an execution of delivery processing.

3. The image forming apparatus as claimed in claim 1,
wherein the first user information further includes a first remaining amount of money information of the user to be stored as a second remaining amount of money information of the user of the second user information in the storage unit, and
wherein the second control unit utilizes, when an amount of money is charged for the execution of the processing flow, the second remaining amount of money information of the user of the second user information stored in the storage unit.

4. The image forming apparatus as claimed in claim 1,
wherein when a logout of a user who is logged in to the first control unit is requested, the first control unit carries out the logout of the user who is logged in to the first control unit, provided that the user who is logged in to the first control unit has been logged out from the second control unit.

5. The image forming apparatus as claimed in claim 4,
wherein the logout process includes a first logout process that is explicitly requested by the user and a second logout process that is automatically requested within the image forming apparatus, and
wherein the second control unit deletes, provided that the first logout process is requested, the second user information stored in the storage unit.

6. A delivery processing system comprising:
an image forming apparatus including a first control unit configured to control functions of the image forming apparatus and include an output unit configured to output, provided that a first user authentication is successful, a first user information including a first user identification information and password combination; and a second control unit configured to control an execution of a processing flow composed of types of processing related to an image data delivery and include an acquisition unit configured to acquire the first user information including the first user identification information and password combination output from the first control unit and store the first user information including the first user identification information and password combination acquired from the first control unit as a second user information including a second user identification information and password combination in a storage unit, and an authentication control unit configured to control a second user authentication based on the second user identification information and password combination of the second user information stored in the storage unit, the first and the second control units operating in separate processes and respectively carrying out the first and second user authentications;
an authentication server configured to carry out the first user authentication for the first control unit of the image forming apparatus; and
a delivery server configured to carryout the second user authentication for the second control unit of the image forming apparatus.

7. The delivery processing system as claimed in claim 6,
wherein the first user information further includes one of a first email address of a user and a first home folder of the user to be stored as a second email address of the user and a second home folder of the user of the second user information in the storage unit, and
wherein the second control unit sets one of the second email address of the user and the second home folder of the user of the second user information stored in the storage unit as a delivery destination and requests the delivery server to carry out an execution of the processing flow.

8. The delivery processing system as claimed in claim 6,
wherein the first user information further includes a first remaining amount of money information of the user to be stored as a second remaining amount of money information of the user of the second user information in the storage unit, and
wherein the second control unit utilizes, when an amount of money is charged for an execution of the processing flow, the second remaining amount of money information of the user of the second user information stored in the storage unit.

9. The delivery processing system as claimed in claim 6,
wherein when a logout of a user who is logged in to the first control unit is requested, the first control unit carries out the logout of the user who is logged in to the first control unit, provided that the user who is logged in to the first control unit has been logged out from the second control unit.

10. The delivery processing system as claimed in claim 9,
wherein the logout process includes a first logout process that is explicitly requested by the user and a second logout process that is automatically requested within the image forming apparatus, and
wherein the second control unit deletes, provided that the first logout process is requested, the second user information stored in the storage unit.

11. A method for processing an image in an image forming apparatus including a first control unit configured to control functions of the image forming apparatus and include an output unit configured to output, provided that a first user authentication is successful, a first user information including a first user identification information and password combination; and a second control unit configured to control an execution of a processing flow composed of types of processing related to an image data delivery and include an acquisition unit configured to acquire the first user information including the first user identification information and password combination output from the first control unit and store the first user information including the first user identification information and password combination acquired from the first control unit as a second user information including a second user identification information and password combination in a storage unit, and an authentication control unit configured to control a second user authentication based on the second user identification information and password combination of the second user information stored in the storage unit, the first and the second control units operating in separate processes and respectively carrying out the first and second user authentications; the method comprising:
outputting, provided that the first user authentication is successful, the first user information including the first user identification information and password combination from the first control unit to the second control unit;
acquiring the first user information including the first user identification information and password combination output from the first control unit to the second control unit;
storing the first user information including the first user identification information and password combination acquired from the first control unit as the second user information including the second user identification information and password combination; and
controlling the second user authentication based on the second user identification information and password combination of the second user information stored in the storage unit.
